(19) United States
(12) Patent Application Publication
(10) Pub. No.: US 2009/0194653 A1
(43) Pub. Date: Aug. 6, 2009

(54) Vent clip

(76) Inventor: Robert Vincent Andrews, Prineville, OR (US)

Correspondence Address: Thomas M. Spear, Jr., P.O. Box 1274, Bend, OR, 97709-1274, US

(21) Appl. No.: 12/322,138

(22) Filed: Jan. 28, 2009

Related U.S. Application Data
(60) Provisional application No. 61/063,100, filed on Feb. 1, 2008.

(51) Int. Cl. F16B 2/24

(52) U.S. Cl. 248/222.13

(57) ABSTRACT

A vent clip for securing a foundation vent damper in a closed or open position being constructed of a clip portion from a linear piece of plastic, generally a thermoplastic, having two ends in which the ends of the clip portion are brought together with a folded middle that is shaped to create a pinching portion between the two ends; a handle placed around an exterior of the clip portion; a pair of clip arms extending from the ends of the clip portion and away from the handle; an access aperture created by a space between the clip arms; and a clip opening where the ends of the clip portion come together, wherein a user secures the damper in either the closed or open position and after the damper is in place, then the user places the clip arms over a center support wall of a foundation vent sliding the center support wall into the access aperture and through the clip opening. If the dampers are being placed in the closed position the vent clip is pushed onto the center support wall until the clip arms touch the dampers with the pinch portion secured to the center support wall. To keep the dampers open, the dampers are opened and the vent clip is placed over the center support wall just above the dampers securing the dampers into the open position.

### CROSS REFERENCE TO RELATED APPLICATION

Applicant claims the benefit of previously filed Provisional Patent Application 61/063,100

### BACKGROUND OF THE INVENTION

The present invention is directed toward improving crawl space ventilation vents. Crawl space vents are installed in the foundation walls of buildings and homes. Vents are placed in the foundation to allow the transfer of air from the crawl space under the flooring in a building or home to the outside atmosphere and outside atmosphere to replace the air in the crawl space. Foundation vents come in many shapes, sizes and configurations. Vents typically have one or more dampers or dampers that allow the vents to be opened and closed—open, meaning air is able to circulate into and out of the crawl space from the outside. Dampers are generally left open to allow moisture that can collect in the crawl space to escape. Sometimes it is desired to close the dampers, for example to prevent freezing pipes in the winter, but the dampers are unable to be closed for various reasons. The present invention provides a device that can be used on a variety of vents for closing the dampers easily and efficiently. A vent clip is used to keep the damper closed and can readily be removed when the damper needs to be opened.

Foundation vents are used to minimize the amount of moisture that can collect in the crawl space of the building or home. Moisture from the ground under the building or home generates humidity in the crawl space. Depending on the amount of moisture in the soil, the temperature in the crawl space, outside humidity and various other climate conditions, the moisture in the crawl space air can condense on the foundation walls and subfloor structure. When moisture collects on some building materials, the water can create mildew and eventually wooden structures can develop wood rot. Therefore, vents are installed to allow the excess moisture to escape from under the building or home and prevent water damage to the subfloor structure and foundation.

Depending on a number of factors, primarily moisture content in the ground and outside temperature the dampers should be closed to minimize cold air from entering the crawl space. Closing the dampers minimizes the amount of heat loss generated by a home's interior heating and ventilation and air conditioning system (HVAC). Another reason to close the dampers is to prevent water pipes, which are placed in the crawl space, from becoming frozen. Frozen water pipes frequently burst and can cause significant damage to homes subfloor structure. In order to keep crawl space temperatures above freezing temperatures, the dampers are frequently closed. Many dampers are able to close with no difficulty but it has been found that many dampers are unable to close or require other materials in order to close the dampers.

The foundation of most buildings and homes is made from concrete. Generally, when the concrete foundations are poured the vents are placed in the foundation. Once the vents are placed in a foundation form and the concrete is poured, the concrete will dry or set and the vents are firmly in place. Vents are generally rectangular in shape with the outside frame being divided into two spaces—separated by a center support wall. Many of the vents installed over the last several decades have been made from plastic; the rectangular shape of the vents becomes slightly irregular as the concrete sets around the plastic frame. This irregularity in the frames is one reason the dampers do not always close or the dampers are unable to remain shut when closed.

It has been observed by the applicant that the dampers are unable to be closed or do not remain in the shut position when closed. The applicant has observed that when the dampers open when they are supposed to be closed, the crawl space temperature can become sufficiently cold as to freeze pipes. It has also been observed that when the dampers are unable to be closed, the owner or resident of the building or will use various devices to shut the dampers, including; bricks, rocks, polystyrene foam and other objects to block or keep the dampers shut.

The applicant has developed a device that can be used on a variety of foundation vents or of various dimensions that allow the owner or occupant of the building or home to quickly and efficiently close the dampers.

### BRIEF SUMMARY OF THE INVENTION

A vent clip for securing a foundation vent damper in either a closed or open position constructed of a clip portion made from a linear piece of thermoplastic plastic having two ends in which the ends of the clip portion are brought together with a folded middle that is shaped to create a pinching portion between the two ends; a handle placed around an exterior of the clip portion; a pair of clip arms extending from the ends of the clip portion and away from the handle; an access aperture created by a space between the clip arms; and a clip opening where the ends of the clip portion come together.

A user can secure foundation vent damper in the closed position by placing the damper in the closed position, then placing the clip arms over a center support wall of the foundation vent sliding the center support wall into the access aperture and through the clip opening until the clip arms touch the dampers or the folded middle touches the center support wall with the pinch portion secured to the center support wall.

To keep the damper in the open position, the user places the damper in the open position, then the user places the clip arms over the center support wall just above the damper then sliding the center support wall into the access aperture and through the clip opening until the clip arms touch a screen on the foundation wall or until the folded middle touches the center support wall with the dampers secured beneath the vent clip and the pinch portion secured to the center support wall.

Besides being made from a thermoplastic, the vent clip can be made from steel, aluminum or other metals. Due to the variety of sizes and shapes of foundation vents, the vent clip has break points placed on the clip arms wherein the clip arms can be shortened by bending the clip arms at the break points breaking off the bent portion of the clip arms allowing the user to push the clip opening further onto the center support wall.

### BRIEF DESCRIPTION OF SEVERAL VIEWS OF THE DRAWINGS

FIG. 1 is a top plan view of a vent clip.

FIG. 2 is a front end plan view of the vent clip.

FIG. 3 is a back end plan view of the vent clip.

FIG. 4 is a side view of the vent clip.

FIG. 5 is a left hand perspective view of a foundation vent.

FIG. 6 is left hand perspective view of the foundation vent with a vent clip partially inserted on the center support wall.

FIG. 7 is a left hand perspective view of the foundation vent with the vent clip inserted near the top of the center support wall with the clip arms shortened and the dampers in the closed position.

FIG. 8 is a left hand perspective view of the foundation vent with the vent clip inserted near the bottom of the center support wall with the dampers in the open position.

### DETAILED DESCRIPTION OF THE INVENTION

Various embodiments of the invention will now be described. The following descriptions provide specific details for a thorough understanding and enabling description of these embodiments. One skilled in the relevant arts will understand, however, that the invention may be practiced without many of these details. Additionally, some structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

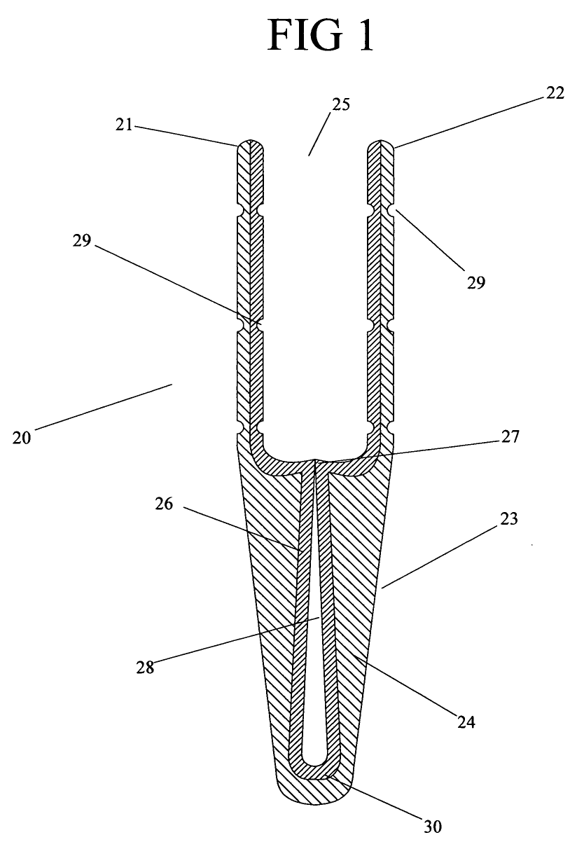

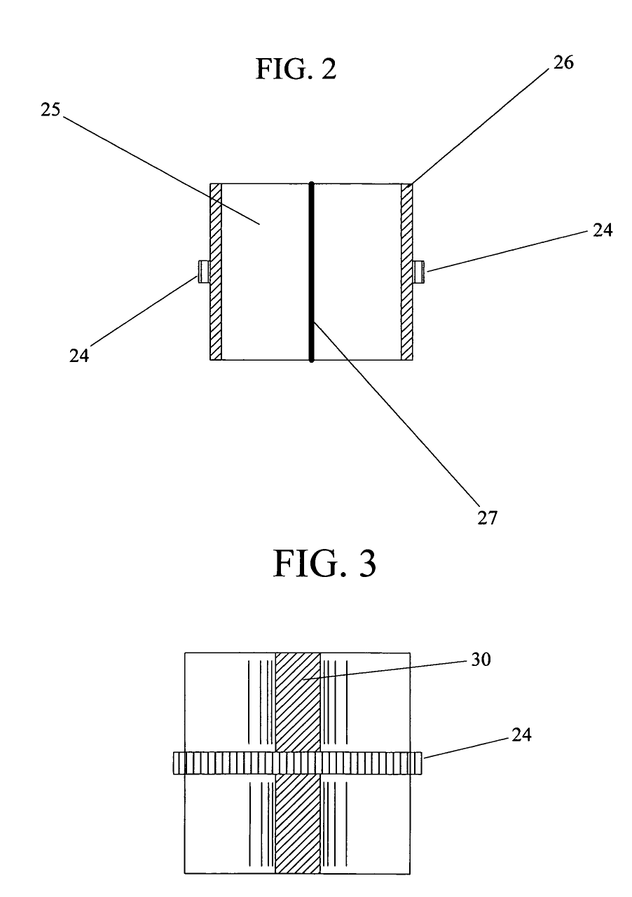

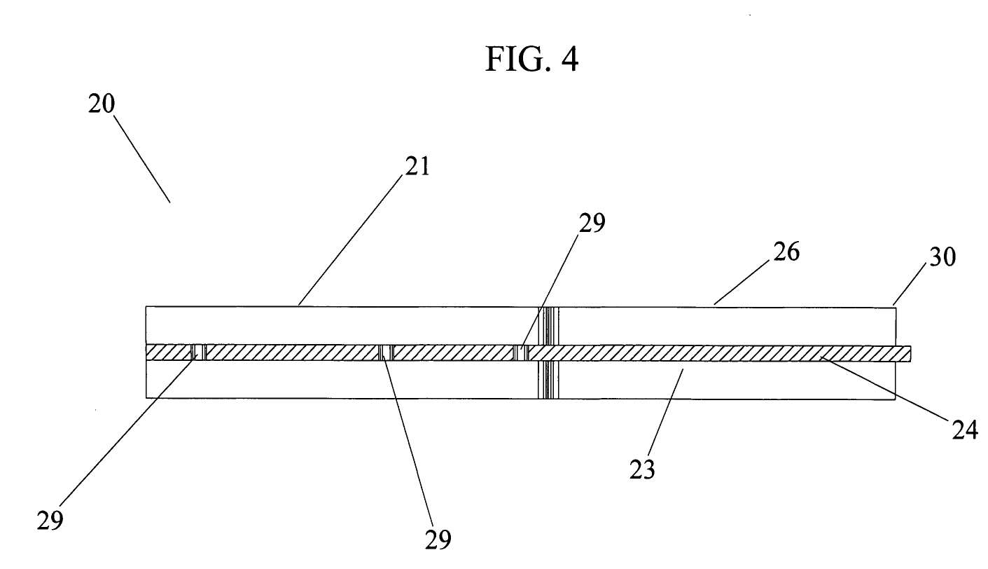

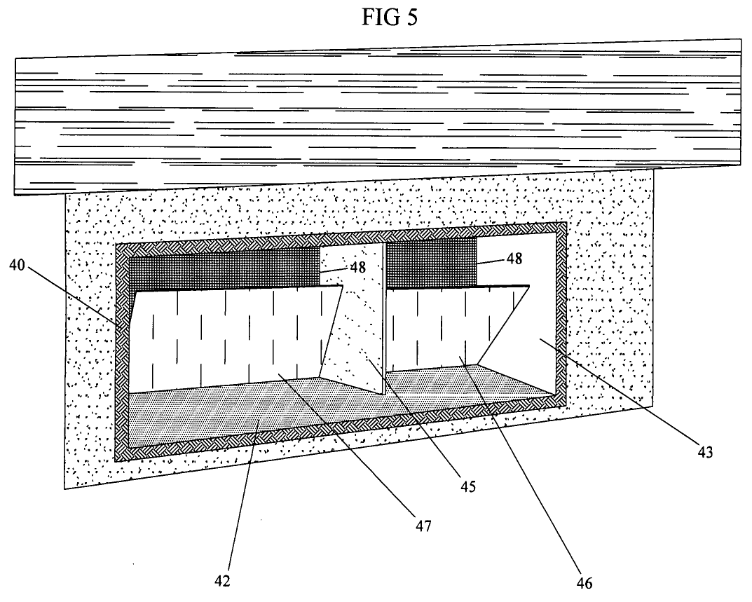

A vent clip 20 is shown is FIGS. 1, 2, 3 and 4. The vent clip is constructed of; a clip portion 26; a pair of clip arms 21 and 22; an access aperture 25; a handle 23, which has a ridge 24 that runs from the tip of the clip arms to the back end of the vent clip; the clip portion 26 having a clip opening 27, a folded middle 30 and a pinch portion 28; and a number of break points 29 on the clip arms.

The vent clip is typically made from a thermoplastic with a melting temperature above 200° C. Plastics such as polyvinylchloride (PVC), nylon, polycarbonates, can be used for making the vent clip. Other material such as steel, aluminum or other metals can be used in place of plastic. The preferred material for the vent clip is a thermoplastic, and one that is impact and temperature resistant. If other materials, other than a thermoplastic, are used some modifications to the design of the vent clip may be necessary to ensure proper functioning of the device. The use of a harder plastic allows the vent clip to be placed upon a foundation vent 40 in the preferred manner.

The clip is generally made from a linear piece of plastic having two ends coming together at the clip opening 27 with a folded middle 30 bent and shaped such that the space between the two ends creates a pinch portion 28, with the pinch portion sized to create a pinching force between the two ends.

The foundation vent 40 is made of a ceiling 41, a floor 42, a right wall 43, a left wall 44, and center support wall 45, a right damper 46; a left damper 47; and a screen 48, see FIG. 5. In this figure, the dampers 46 and 47 are partially open. When the dampers 46 and 47 are open, the foundation vent 20 allows air to circulate from the crawl space to the atmosphere to minimize the amount of moisture retained in the crawl space. When the dampers are open, a screen 48 placed on the backside of the foundation vent is used to limit animals and insects from entering the crawl space.

The dampers of foundation vents used in recently built homes are made from a hard durable plastic. Prior to when the foundation is poured, the foundation vent is placed in the forms of the foundation wall. As the cement dries around the foundation vent 40 it is not unusual for the vent walls, floor and ceiling to warp. When the walls warp it can become difficult to shut the dampers 46 and 47. It has been observed that even if the dampers are able to be shut, the dampers do not always remain in the shut position due to the irregularities of the foundation vent walls, floor and ceiling. It has been observed by the applicant that rocks, bricks, or other items are used to keep the dampers in the shut position. The vent clip 20 is used to secure the dampers in a shut position when it is desired to have them shut and can be used to keep the dampers in the open position as well.

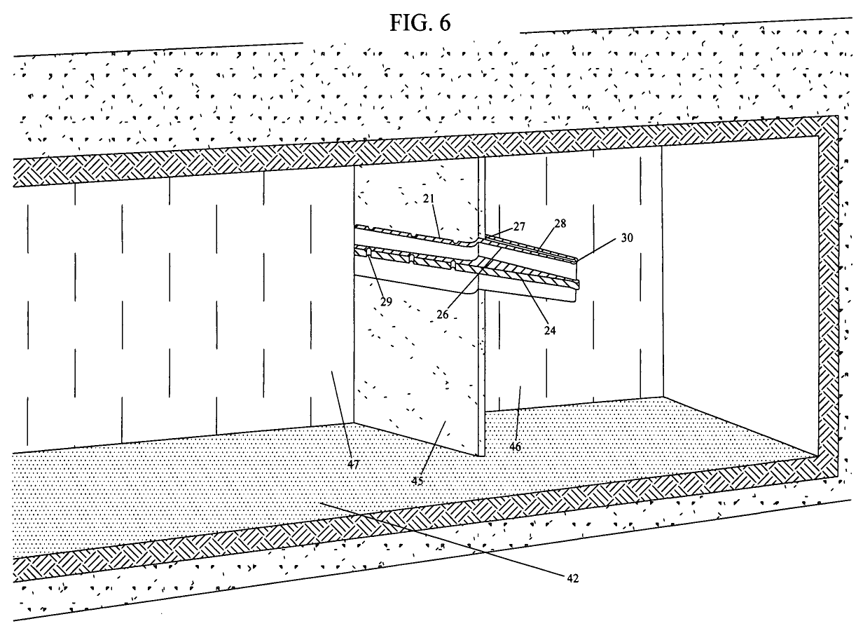

To place the dampers 46 and 47 in the shut position, the dampers are manually placed in the shut position, FIG. 6 and the access aperture 25 of the vent clip 20 is placed over the center support wall 45. The vent clip is then slid over the center support wall until the clip opening 27 hits the center support wall, FIG. 6. The clip is then pushed further onto the center support wall 45 with the pinch portion 28 of the clip securing itself to the center support wall by the pinching force between the two ends of the clip portion 26.

The vent clip 20 and more specifically the pinch portion 28 is able to slide further over the center support wall 45 until the access aperture 25 and tips of the clip arm comes up against the dampers 46 and 47 in their shut position or until the folded middle 30 of the clip portion touches the center support wall 45 of the foundation vent 40.

If the center support wall is not very deep, meaning the clip arms come up against the dampers before the clip opening 27 touches the center support wall when placing the vent clip onto the foundation vent, then the clip arms 21 and 22 need to be shortened in order to allow the pinch portion 28 of the clip portion 26 to be adequately secured to the center support wall 45, the clip arms 21 and 22 can be shortened by breaking off a portion of the clip arms at one of the break points 29.

The clip arms 21 and 22 can be shortened by bending the arms at the desired break point 29 on the clip arms. By bending the arms, a portion of the plastic arms can be broken leaving shorter arms. By shortening the clip arms this allows for the pinch portion 28 of the clip portion 26 to be pushed further onto the center support wall 45.

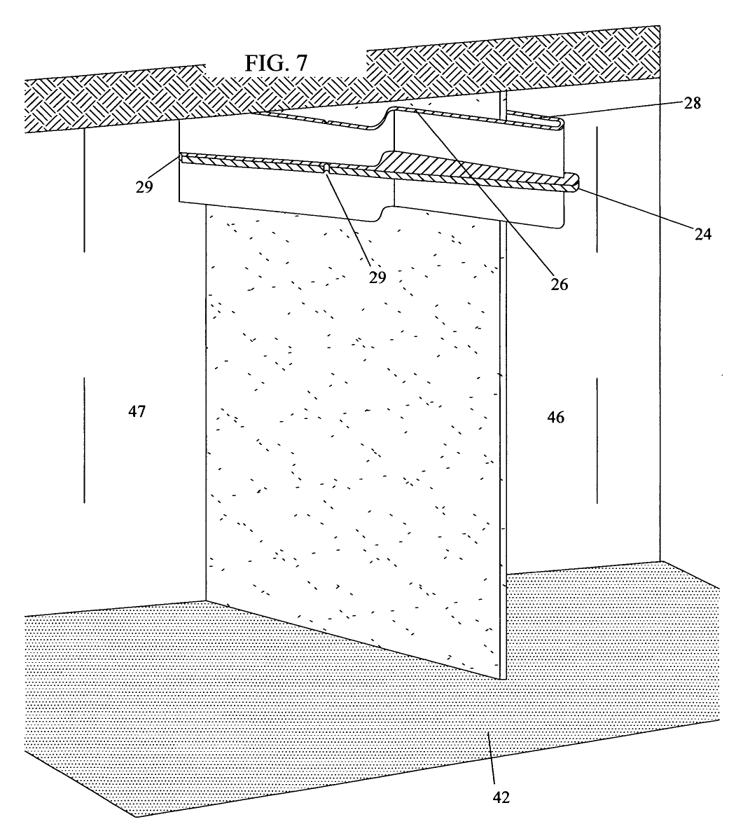

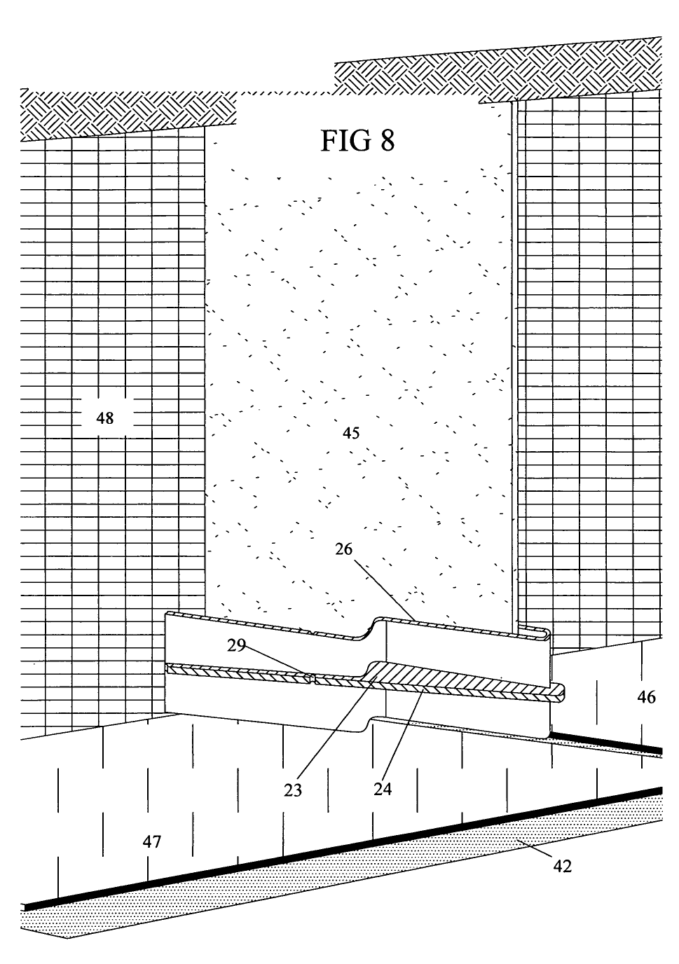

In FIG. 7, the vent clip 20 is placed onto the center support wall 45 near the top of the foundation vent 40. The dampers 46 and 47 are in the closed position and the pinch portion 48 of the vent clip is squeezing against the center support wall 45 securing the vent clip into place.

The vent clip is typically placed near a top edge of the center support wall to provide better leverage for keeping the dampers in the shut position but other positions are able to be used as well.

The depth of the center support wall 45 may require a person installing the vent clip to shorten the vent clip arms 21 and 22. If the center support wall is shallow, the arms do not need to be as long. A number of break points 29 are placed on the clip arms. These break points 29 are used to shorten the length of the vent clip 20 by shortening the clip arms. The installer just needs to bend the clip arms at the point of one of the break points 29 and the concave indent will break, especially if the material is a hard plastic like polyvinylchloride (PVC) or a polycarbonate.

The installer will typically close the dampers 46 and 47 to minimize temperature drops in the crawl space during cold weather and therefore preventing water pipes located in the crawl space from becoming frozen. Another benefit from using the vent clips is to reduce the amount of heat energy lost to the atmosphere from the crawl space during cold spells. Vent clips also can be used on vents that have damaged screens to prevent animals and insects from going into the crawl space. The vent clips allow for an easy and efficient way to shut the dampers of the foundation vents.

The vent clips, when not being used to keep the dampers 46 and 47 in a shut position, can be used to keep the dampers in the open position. It has also been observed that the dampers 46 and 47 are sometimes difficult to keep fully open. The vent clips 20 can be used to keep the dampers in the fully open position. The dampers 46 and 47 are manually placed in the fully open position, FIG. 8. When the dampers are in the fully open position, the vent clip 20 is installed on the center support wall 45 at the lower end of the center support wall 45 near the foundation vent floor 42. The vent clip access aperture 25 is placed such that the clip arms 21 and 22 are on either side of the center support wall 45 near the floor of the foundation vent. The vent clip 20 is pushed onto the center support wall 45 such that the clip opening 27 is opened due to the pressure from pushing the clip opening over the center support wall. The pinch portion 28 fits against the center support wall 45 and keeps the vent clip in position with the clip arms and pinch portion keeping the dampers 46 and 47 pressed against the foundation vent floor 42.

The user is able to secure the dampers in a fully open, FIG. 8 or shut, FIG. 7, position by manually placing the dampers in the desired position and pushing the vent clip 20 onto the center support wall in the desired position. The vent clips can be kept secured to the center support wall throughout the year without having to remove and store the clips during portions of the year.

I claim:

1. A vent clip for securing a foundation vent damper in a closed position comprising: a clip portion made from a linear piece of thermoplastic having two ends in which the ends of the clip portion are brought together with a folded middle that is shaped to create a pinching portion between the two ends; a handle placed around an exterior of the clip portion; a pair of clip arms extending from the ends of the clip portion and away from the handle; an access aperture created by a space between the clip arms; and a clip opening where the ends of the clip portion come together, wherein a user secures the damper in the closed position by placing the damper in the closed position, then the user places the clip arms over a center support wall of a foundation vent sliding the center support wall into the access aperture and through the clip opening until the clip arms touch the dampers or until the folded middle touches the center support wall with the pinch portion secured to the center support wall.

2. The vent clip of claim 1 for securing the damper in an open position wherein a user places the damper in the open position, then the user places the clip arms over the center support wall just above the damper then sliding the center support wall into the access aperture and through the clip opening until the clip arms touch a screen or the folded middle touches the center support wall with the dampers secured beneath the vent clip with the pinch portion secured to the center support wall.

3. The vent clip of claim 1 wherein the vent clip is made from a metal.

4. The vent clip of claim 2 wherein the vent clip is made from a metal.

5. The vent clip of claim 1 further comprising break points placed on the clip arms wherein the clip arms can be shortened by bending the clip arms at the break points breaking off the bent portion of the clip arms allowing the user to push the clip opening further onto the center support wall.

6. The vent clip of claim 2 further comprising break points placed on the clip arms wherein the clip arms can be shortened by bending the clip arms at the break points breaking off the bent portion of the clip arms allowing the user to push the clip opening further onto the center support wall.
